(19) United States
(12) Patent Application Publication
(10) Pub. No.: US 2009/0126852 A1
(43) Pub. Date: May 21, 2009

(54) Gift Popup Decoration and Card and Method

(76) Inventor: Patricia Miller, Franklinton, LA (US)

Correspondence Address: Mark E. Andrews, 7104 Coliseum St., New Orleans, LA, 70118, US

(21) Appl. No.: 12/268,052

(22) Filed: Nov. 10, 2008

Related U.S. Application Data
(60) Provisional application No. 60/986,794, filed on Nov. 9, 2007.

(51) Int. Cl. B32B 37/00; G09F 19/00

(52) U.S. Cl. 156/60; 428/9

(57) ABSTRACT

Gift Popup Decoration and Card and Method providing a popup decoration for a gift which is substantially flat for transport and storage and which expands into a three-dimensional decoration for a wrapped gift, and an aesthetically-coordinated “to-from” card detachable from the decoration for placement on the same wrapped gift.

### CROSS REFERENCE TO RELATED APPLICATIONS

Priority is claimed from U.S. Provisional Patent Application No. 60/986,794 filed 9 Nov. 2007, which is hereby incorporated by reference.

### BACKGROUND

A wrapped gift is traditionally accompanied by a “to-from” card or label and a ribbon, often finished in a bow. Bows and to-from cards purchased separately from a given wrapping paper might not all match as well as is desired, just as bows and cards purchased separately from each other might not match. A fully made-up bow is cumbersome to package and stock in stores or to ship, and a partially-collapsed bow may be cumbersome to deploy by people lacking the time, inclination, or ability to finish the construction of the bow.

People with mobility or coordination limitations may find it difficult to work with traditional bows. The nature of the activity of occasional gift wrapping is such that a novel product or method may be desirable for its novelty alone, regardless of whether a given user perceives having the limitations addressed by the product or method.

### SUMMARY OF INVENTION

This invention is a Gift Popup Decoration and Card and Method providing a popup decoration for a gift which is substantially flat for transport and storage and which expands into a three-dimensional decoration for a wrapped gift, and an aesthetically-coordinated to-from card detachable from the decoration for placement on the same wrapped gift.

### BRIEF DESCRIPTION OF DRAWINGS

FIG. 1 shows an overview of an embodiment of the invention.

FIG. 2 shows a side view of an embodiment of the popup decoration in collapsed form.

FIG. 3 shows a side view of an embodiment of the popup decoration being deployed.

FIG. 4 shows a side view of an embodiment of the popup decoration fully deployed.

FIG. 5 shows an embodiment of a to-from card after detachment from the popup decoration.

FIG. 6 shows embodiments of the to-from card having various shapes and printed sentiments.

### DISCLOSURE OF INVENTION

This invention is a Gift Popup Decoration and Card and Method providing a popup decoration for a gift which is substantially flat for transport and storage and which expands into a three-dimensional decoration for a wrapped gift, plus an aesthetically-coordinated to-from card detachable from the decoration for placement on the same wrapped gift.

The popup decoration comprises a base-forming material such as card stock or thin cardboard or similar material folded or otherwise hinged in such a way as to create at least two portions opposite at least one fold or hinge. A collapsible decoration is arranged on the card stock in any of a variety of methods known in the art, such as substantially flat pieces that are pulled into a perpendicular position by the opening of the unit, or the attachment of a collapsible web of decoration material to the opposite sides of a fold so that the web is pulled into its three-dimensional state by the opening of the unit. When the unit is in its unopened state, the collapsible decoration is compressed and lies substantially flat, providing easier transport and storage and protecting the decoration from damage.

The popup decoration also comprises a means of being attached to a wrapped gift, such as known adhesive placed on the material such as card stock, with the adhesive being placed on the face of the material opposite the attachment of the popup decoration, being the face of the material forming the bottom of the base of the popup decoration.

Although the popup decoration may have a design which is generally decorative, or may be made in imitation of a traditional bow of ribbons, the decoration may also be designed to have visual effects beyond a traditional bow, and may be designed toward specific types of gifts, such as a standing married couple for a wedding gift or a standing evergreen tree dusted with snow for a midwinter gift.

Initially attached to the popup decoration is a to-from card having a design similar to or coordinated with the popup decoration. The to-from card may be detached from the popup decoration, completed using the names of the gift's recipient and giver, and attached anywhere on the wrapped gift package using a provided attachment means such as adhesive methods known in the art.

The to-from card may have a pre-printed sentiment of either a general nature or specific to any occasion that the coordinated popup decoration is directed toward. For example, the to-from card initially attached to a birthday-targeted popup decoration might read “Happy Birthday”, while for a holidays theme the card might read “Happy Holidays”.

In use, the invention has been purchased by the user in a collapsed and substantially flat configuration. The user detaches the to-from card, which will later be filled out and attached to a wrapped gift to identify the recipient and giver. The user makes any preparations necessary to expose or activate the adhesive means on the bottom of the base of the popup decoration, such as removing a protective strip or moistening an adhesive. Optionally, the attached to-from card may be incorporated as part of a protective strip covering the base of the popup decoration, with the detachment of the to-from card serving to expose or activate the adhesives for both the popup decoration and the to-from card.

In use, the popup decoration may be first deployed by opening the folded unit and then attached to the wrapped gift, or one portion of the folded popup decoration may be attached to the wrapped gift first and then be deployed by unfolding.

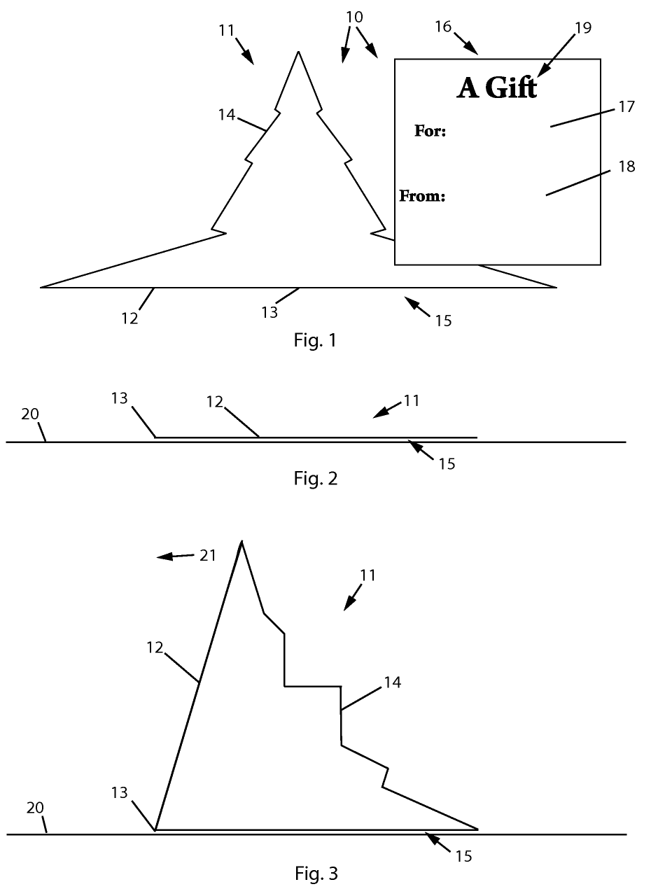

Referring to FIG. 1, the Gift Popup Decoration and Card of the invention 10 is shown, with its components, the popup decoration 11 and the to-from card 16. Material 12 such as card stock is provided a fold 13 or hinge point, and a collapsible decoration 14 is arranged on one face of the material. An adhesive means 15 is provided on the face of the material opposite the collapsible decoration. The deployed popup decoration is meant to be adhered to a wrapped gift. The to-from card 16 is initially attached to the popup decoration and is detachable so that it may be independently adhered to the wrapped gift. The to-from card provides places for the writing of the names of the recipient 17 and the giver 18 of a gift. Optionally, a sentiment 19 is printed on the to-from card.

Referring to FIG. 2, a folded or collapsed popup decoration 11 is shown adhered to a wrapped gift 20.

Referring to FIG. 3, a partially deployed popup decoration 11 is shown adhered to a wrapped gift 20. The material 12 forming the base of the unit is being unfolded about the fold 13 or hinge in the indicated direction 21.

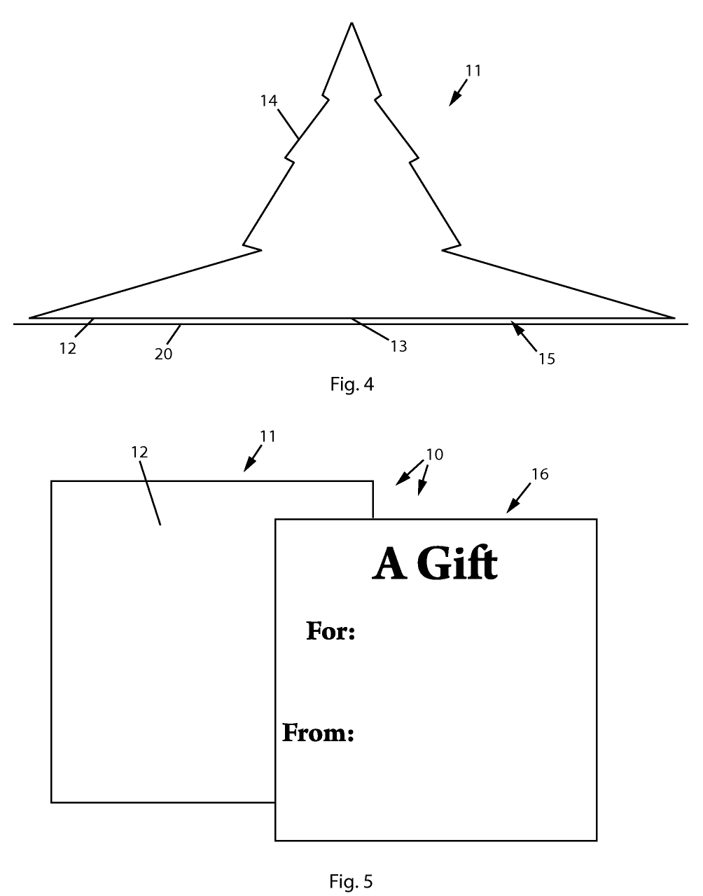

Referring to FIG. 4, a deployed popup decoration 11 is shown adhered to a wrapped gift 20.

Referring to FIG. 5, a to-from card 16 is shown detached from the material 12 of the popup decoration 11.

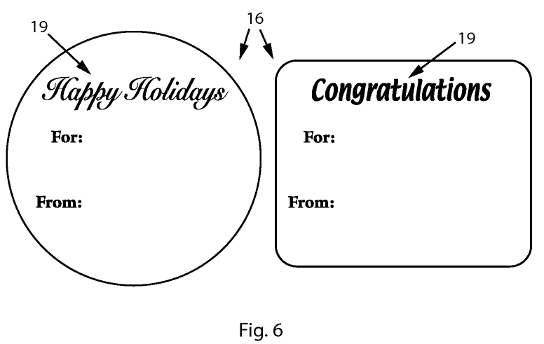

Referring to FIG. 6, various embodiments of a to-from card 16 are shown having various printed sentiments 19.

While this invention has been described in detail with particular reference to its preferred embodiments, the principles and modes of operation of the invention have also been described in this specification. The invention should not be construed as being limited to the particular forms disclosed, which are illustrative rather than restrictive. Modifications, variations, and changes may be made by those skilled in the art without departure from the spirit and scope of the invention as described by the following claims.

I claim:

1. A popup decoration and card for placement on a wrapped gift, comprising:
a base-forming material folded to form at least two portions opposite at least one fold;
a collapsible decoration arranged on one face of said base-forming material;
an adhesive arranged on opposite face of said base-forming material opposite said collapsible decoration;
a to-from card attached to and detachable from said base-forming material; and
an adhesive arranged on said to-from card;
wherein said to-from card is to be detached from said base-forming material, provided with the names of recipient and giver of said wrapped gift, and attached to said wrapped gift, and
wherein said collapsible decoration arranged on said base-forming material is to be attached to said wrapped gift; and
wherein said collapsible decoration arranged on said base-forming material is to be deployed, causing said collapsible decoration to stand substantially perpendicular to said wrapped gift.

2. The popup decoration and card of claim 1, wherein said base-forming material is selected from the list comprising card stock and thin cardboard.

3. The popup decoration and card of claim 1, wherein said collapsible decoration further comprises a substantially flat decoration that may be deployed to stand substantially perpendicular to said wrapped gift.

4. The popup decoration and card of claim 1, wherein said collapsible decoration further comprises a collapsible web that may be deployed to stand substantially perpendicular to said wrapped gift.

5. The popup decoration and card of claim 1, wherein said to-from card is aesthetically coordinated with said collapsible decoration.

6. The popup decoration and card of claim 5, wherein said aesthetic coordination further comprises a unity of visual effect.

7. The popup decoration and card of claim 5, wherein said aesthetic coordination further comprises a unity of gift-giving occasion.

8. A popup decoration and card for placement on a wrapped gift, comprising:
a base-forming material means folded to form at least two portions opposite at least one fold;
a collapsible decoration means arranged on one face of said base-forming material means;
an adhesive means arranged on opposite face of said base-forming material means opposite said collapsible decoration means;
a to-from card attached to and detachable from said base-forming material means; and
an adhesive means arranged on said to-from card;
wherein said to-from card is to be detached from said base-forming material means, provided with the names of recipient and giver of said wrapped gift, and attached to said wrapped gift, and
wherein said collapsible decoration means arranged on said base-forming material means is to be attached to said wrapped gift; and
wherein said collapsible decoration means arranged on said base-forming material means is to be deployed, causing said collapsible decoration means to stand substantially perpendicular to said wrapped gift.

9. A method for decorating and identifying wrapped gifts, comprising:
providing a base-forming material folded to form at least two portions opposite at least one fold;
providing a collapsible decoration arranged on one face of said base-forming material;
providing an adhesive arranged on opposite face of said base-forming material opposite said collapsible decoration;
providing a to-from card attached to and detachable from said base-forming material; and
providing an adhesive arranged on said to-from card;
wherein said to-from card is to be detached from said base-forming material, provided with the names of recipient and giver of said wrapped gift, and attached to said wrapped gift, and
wherein said collapsible decoration arranged on said base-forming material is to be attached to said wrapped gift; and
wherein said collapsible decoration arranged on said base-forming material is to be deployed, causing said collapsible decoration to stand substantially perpendicular to said wrapped gift.

10. The method of claim 9, wherein said base-forming material is selected from the list comprising card stock and thin cardboard.

11. The method of claim 9, wherein said collapsible decoration further comprises a substantially flat decoration that may be deployed to stand substantially perpendicular to said wrapped gift.

12. The method of claim 9, wherein said collapsible decoration further comprises a collapsible web that may be deployed to stand substantially perpendicular to said wrapped gift.

13. The method of claim 9, wherein said to-from card is aesthetically coordinated with said collapsible decoration.

14. The method of claim 13, wherein said aesthetic coordination further comprises a unity of visual effect.

15. The method of claim 13, wherein said aesthetic coordination further comprises a unity of gift-giving occasion.
